(19) United States
(12) Patent Application Publication
(10) Pub. No.: US 2006/0240399 A1
(43) Pub. Date: Oct. 26, 2006

(54) Long-term shelf preservation of cells and multicellular specimens by vitrification

(76) Inventor: Victor Bronshtein, San Diego, CA (US)

Correspondence Address: Victor Bronshtein, 5008 Almondwood Way, San Diego, CA, 92130, US

(21) Appl. No.: 11/471,812

(22) Filed: Jun. 21, 2006

Related U.S. Application Data
(63) Continuation of application No. 09/254,563, filed on Mar. 5, 1999, now abandoned.

(51) Int. Cl. A01N 1/00; A01N 1/02

(52) U.S. Cl. 435/1.3

(57) ABSTRACT

The method of preservation by vitrification, described in the present application, provides for storage of samples at higher temperatures than in conventional methods and can be applied to cells, multicellular tissues, organs and organisms. The method of the present invention includes preparing a solution of vitrification non-permeating co-solutes (amino acids, betaines, carbohydrates, or other non-permeating co-solutes that effectively decrease the chemical potential of permeating cryoprotectants in aqueous solutions), a permeating cryoprotectant and a non-permeating cryoprotectant (polyvinylpyrrolidone, polyethylene glycol, dextran, hydroxy ethyl starch, Ficoll, etc.), contacting a sample with the vitrification solution and storing the sample at a storage temperature. The method also includes the step of rehydrating the preserved sample in a rehydration solution prepared in the manner of the vitrification storage solution. The present invention is also directed to a vitrification solution and a rehydration solution as described in connection with the method.

### RELATED APPLICATIONS

Present application is a continuation and claims the benefit of priority of U.S. patent application Ser. No. 09/254,563, filed Mar. 5, 1999, the entire disclosure of which is incorporated by reference.

### BACKGROUND OF THE INVENTION

1. Field of Invention

This invention relates to the long-term shelf preservation of cells and multicellular specimens by vitrification. The invention is directed to the optimization of vitrification and rehydration solutions, as well as vitrification, and rehydration procedures.

2. Description of the Related Art

Low temperature preservation of cells and multicellular specimens by traditional freezing methods is not uncommon. However, the strong damaging action of ice crystallization limits the effectiveness of such cryogenic methods to the cryopreservation of single cells and multicellular specimens. Vitrification is an alternative approach to cryopreservation that utilizes solidification of samples during cooling, without formation of ice crystals (Fahy, G. M. et al., 1984). Conventionally, cryopreservation by vitrification of single cell (erythrocyte, stem cells, sperm, E. Coli, yeasts and other cellular microorganisms, etc.) and multicellular specimens provide for storage of cryopreserved samples at −196.degree. C. in liquid N.sub.2. However, there is currently a need for reliable methods for long-term shelf preservation at refrigeration or higher temperatures. We believe that development of these methods was not possible because of several generally accepted misconceptions and deficiencies of the prior art that have been addressed by the inventor (Bronshtein, V. L., 1995a).

### Effects of Dehydration

Ice formation at low temperatures can be avoided only if samples are sufficiently dehydrated. Dehydration is known to damage cells. The damaging effect of dehydration increases with increasing osmotic pressure (concentration) and depends strongly upon whether the vitrification solution contains permeating cryoprotectants. For example, cells normally cannot survive equilibration in solutions containing only non-permeating solutes in concentration >1 mol/l. However, many types of cells can easily tolerate equilibration in solutions containing permeating cryoprotectants in much higher concentrations. This is because penetration of cryoprotectants protects cells against dehydration damage.

Here, it is important to note that dehydration does not mean a decrease in the cell volume which actually may be very damaging (Meryman, H. T., 1967, Meryman, H. T., 1970). The term “dehydration” means removal of water, or increase in the osmotic pressure. Erroneous use of this term resulted in several misconceptions. For example, as described below, dehydration by itself is not a strong damaging factor. Dehydration may even be a protective factor, as performed according to the present invention.

As shown in Bryant, G. et al. (1992) damage of unloaded specimens during dehydration in vitrification solution is caused by hydration forces occurring between biological macromolecules and membranes when distances between them become small as a result of dehydration. It is believed that loading of cells with permeating cryoprotectants, protects against subsequent dehydration because intracellular cryoprotectant diminishes these forces. Therefore, some amount of intracellular cryoprotectants are required to protect cells during dehydration to high osmotic pressures. For this reason, Rall proposed equilibration of biological specimens in loading solutions of permeating cryoprotectants (dimethylsulfoxide (DMSO), ethylene glycol (EG), propylene glycol (PG), glycerol, etc.) prior to dehydration, in order to reduce the strong damaging effect of dehydration in the vitrification solution (Rall, W. F. et al., 1985a). Unfortunately, the protective effect of loading significantly decreases with increasing time of equilibration in vitrification solution. Currently, this effect is erroneously explained as a direct toxic effect of high concentration of intracellular cryoprotectants.

### Apparent Toxicity of Vitrification Solution

Based on the general belief that intracellular cryoprotectants help to vitrify cytosol, and the fact that some intracellular cryoprotectant is required to protect cells during dehydration, penetration of cryoprotectant inside cells may be considered as a beneficial phenomena. A negative aspect of this penetration, considered in the literature, is associated with direct chemical toxicity of cryoprotectants (Fahy et al., 1990). Because the toxicity is believed to be proportional to the concentration of cryoprotectants (not to the amount of cryoprotectants inside a cell) three basic approaches have been proposed to minimize the toxicity (for details see review of Steponkus, P. L. et al., 1992):
1. to use a mixture of different cryoprotectants;
2. to add components that may act as “toxicity neutralizers”; and
3. to identify solutes that will form a glass at a lower concentration.

However, Fahy found that biochemical studies of the toxicity to date have not adequately demonstrated the mechanisms of toxicity (Fahy et al., 1990). This actually means that the direct chemical toxicity of typical permeating cryoprotectants (EG, PG, glycerol and DMSO) is small. Therefore, in agreement with the conclusion of Fahy et al., 1990, present concepts of cryoprotectant toxicity are in need of serious revision.

Recently, Langis, R. et al. (1990) demonstrated that survival of isolated rye protoplast, following a dehydration step, is a function of osmolarity rather than the concentration of vitrification solutions. Based on this observation, Steponkus, P. L. et al. (1992) discussed an alternative strategy for formulating less toxic solutions with lower osmolarity.

As mentioned above, cells can tolerate dehydration in very concentrated vitrification solution for several minutes if they have been loaded with permeating cryoprotectants. However, during long equilibration times in vitrification solution, cell survival decreases with increasing time of equilibration. Because loading of cells with permeating cryoprotectants protects against injury subsequently occurred after dehydration in vitrification solutions, in the case of short dehydration times one may suggest that the injury depends primarily on osmolarity. However, because the concentration of intracellular cryoprotectants that is reached after dehydration increases with increasing osmolarity of vitrification solution, the existing experimental observations do not answer the question whether damage of dehydrated embryos is a result of the increased concentration of intracellular cryoprotectant, or the increase in osmotic pressure. In both cases, however, the questions as to why the injury increases with dehydration time remains to be answered. It is also very important because the time required to complete dehydration of multicellular specimens can be substantially longer than that for individual cells.

Bronshteyn, V. L. et al. (1994) and Steponkus, P. L. et al. (1994) discussed an alterative strategy for formulating less toxic solutions with lower osmolarity. As mentioned above, cells can tolerate dehydration in very concentrated vitrification solution for several minutes if they have been loaded with permeating cryoprotectants. However, during longer equilibration times in vitrification solutions, cell survival decreases with increasing time of equilibration. Because loading of cells with permeating cryoprotectants protects against injury occurring after dehydration in vitrification solution, in the case of short dehydration times, one may suggest that the injury depends primarily on osmolarity. However, because the concentration of intracellular cryoprotectant that is reached after dehydration increases with increasing osmolarity of vitrification solution, the existing experimental observations do not answer the question of whether damage is a result of the increased concentration of intracellular cryoprotectant or an increase in osmotic pressure. In both cases, no answer is presented as to why injury increases with dehydration time. This answer is very important because the time required to complete dehydration of multicellular specimens can be substantially longer than that for individual cells.

Bronshteyn, V. L. et al. (1994) and Steponkus, P. L. et al. (1994) suggest that a significant part of the apparent toxicity of ethylene glycol-based vitrification for loaded Drosophila melanogaster embryos is associated with ethylene glycol permeation (increase in mass of ethylene glycol inside embryos) rather than with chemical toxicity of intra-embryo ethylene glycol, or osmotic pressure of vitrification solution. The injurious effect of permeation of cryoprotectants during equilibration in vitrification solution was also demonstrated in the studies performed with mouse embryos (Zhu, S. E. et al., 1993, Tachikawa, S. et al., 1993 and Kasai, M. et al., 1990). This toxic effect is not related to the increase in intracellular osmotic pressure or biochemical toxicity of cryopreservation because after water efflux from loaded cells, the osmotic pressure and concentration of cryoprotectant inside cells is approximately equal to that outside the cells.

It is believed that influx of penetrating cryoprotectants through the cell membrane during equilibration in vitrification solution containing high concentrations of penetrating cryoprotectants is a main cause of cell damage that occurs during subsequent washing out of the cryoprotectants after cryopreservation.

### Kinetics of Cryoprotectant Permeation Inside Cells

After the classical work of Kedem, O. et al. (1958) it was generally accepted that the thermodynamic force responsible for cryoprotectant permeation inside cells is proportional to the cryoprotectant concentration gradient across the cell membrane independent of the composition of the vitrification solution. However, Bronshteyn, V. L. et al. (1994) found that amino acids (glycine and glutamic acid) and carbohydrates (sucrose and sorbitol) significantly diminished ethylene glycol permeation inside Drosophila melanogaster embryos. The preventive effect of amino acids was impressive because 1 wt % of glutamic acid+0.5 wt % glycine practically prevented ethylene glycol permeation inside embryos for up to three hours of equilibration in vitrification solution containing 42 wt % ethylene glycol. The preventive effect of carbohydrates was about four times smaller. These observations show that the approach described in Kedem, O. et al. (1958) and qualitative conclusions obtained based on this model cannot be used to analyze and predict permeation of cryoprotectant inside cells during equilibration in vitrification solution.

Interaction Between Cryoprotectants and Proteins

Timasheff, S. N. (1993) criticized the belief that cryoprotectants form some sort of coating or shell that protects proteins from denaturation during cryopreservation. His criticism was based on the articles of Gekko, K. et al. (1981), Lee, J. C. et al. (1981) and other publications, reporting that cryoprotectants excluded from the surface of proteins. Bronshtein, V. L. (1995b) submitted that the above conclusion of Timasheff and his co-workers is questionable for two reasons. First, the thermodynamic equilibrium in the dialysis experiments of Timasheff and his co-workers cannot be obtained if the hydrostatic pressure inside the dialysis bag is equal to the pressure outside the bag. The suggestion that the effect of this difference in the hydrostatic pressures is negligible is incorrect. Second, amino acids limit penetration of cryoprotectants inside the cell by decreasing the chemical potential of cryoprotectants in the extracellular aqueous solution (Bronshteyn and Steponkus, 1994). Therefore, cryoprotectant adsorbs at the surface of proteins and partially replaces water molecules hydrating the proteins. The amount of water of hydration, that is, the amount of water at the protein surface that is replaced by molecules of cryoprotectant, increases with increasing concentration of cryoprotectant.

Crowe, J. H. et al. (1990) suggested that freezing and dehydration may be different stress vectors because they found that stabilization of proteins during drying occurs because of an attraction between sugars and proteins. The inventor believes that vitrification of the solution (“shell”) at the surface of proteins (and biological membranes) is a general mechanism of protection equally valid for freezing and desiccation.

Effects of Intracellular Cryoprotectants on the Stability of Intracellular Amorphous State at Low Temperatures

Steponkus, P. L. et al. (1992) have shown that decreasing osmolarity of the vitrification solution decreases the damaging effect of dehydration in vitrification solution if the dehydration time is several minutes or less. However, to obtain cell survival after cryopreservation, one should successfully vitrify both the extracellular solution and the cytosol. For this reason, Steponkus et al. (1992) suggested that the better cryoprotectant for the loading step is one that allows stable vitrification of cytosol after dehydration in vitrification solution with lower osmolarity. This suggestion was a reflection of a general belief that the presence of cryoprotectants inside cells helps to vitrify cytosol. However, our recent studies (Bronshtein, in preparation) have shown that vitrification temperature of the maximum freeze dehydrated Bovine Serum Aldumin (BSA) solution is T.sub.g=−20.degree. C. In these studies, T.sub.g was estimated as a temperature of detectable onset of ice melting endotherm. Therefore, T.sub.g in protein solutions is much higher than in solutions of permeating cryoprotectants. This suggests that stability of dehydrated cytoplasm that does not contain cryoprotectants is much higher than that of solutions of permeating cryoprotectants with the same osmotic pressure. This agrees with observations (Steponkus et al., 1992; Langis and Steponkus, 1990) obtained for protoplasts from acclimated rye leaves. They found that the protoplast “loaded with ethylene glycol must be subjected to greater dehydration than those not loaded with ethylene glycol to achieve maximum survival after storage in liquid nitrogen.” Bronshteyn and Steponkus (1993) found that intraembryo freezing in non-loaded Drosophila melanogaster embryos after dehydration in vitrification solution, occurs at significantly lower temperatures compared to those loaded with 2.125 M ethylene glycol during cooling at 5.degree. C./min. Therefore, contrary to the conventional point of view, addition of low molecular weight cryoprotectants into cytoplasm decreases the stability of the cytoplasm. As such, the present invention is based on scientific theories that are opposite to the prior art described above.

It is, therefore, an object of the present invention to provide a preservation method and a cryoprotectant for cryopreserving cells and multicellular specimens that accounts for the newfound facts that use of low molecular weight cryoprotectants can be detrimental to the cryopreservation process. It is a further object of the present invention to provide a preservation method and a vitrification solution for preserving by vitrification extracellular spaces in the specimen.

### SUMMARY OF THE INVENTION

The present invention is directed to a method of preserving cells or multicellular specimens including the step of contacting the specimen with a vitrification solution comprising a permeating cryoprotectant, a non-permeating cryoprotectant and a non-permeating co-solute that limits the amount of the permeating cryoprotectant that permeates the specimen. The method further includes the step of unloading the specimen by contacting the loaded specimen with a rehydration solution comprising a non-permeating co-solute and, optionally, a permeating cryoprotectant and a non-permeating rehydration cryoprotectant, such that cryoprotectant is removed from the cells of the specimen. Furthermore, the cryoprotectants can be loaded or unloaded in a stepwise manner, in a linear manner, or according to a desired profile.

The present invention is also directed to the vitrification and rehydration solutions for use in connection with the method described above.

### DETAILED DESCRIPTION OF THE PREFERRED EMBODIMENTS

The present invention is directed to a method for preserving a biological specimen and compositions for achieving the same. Suitable specimens can be single cells (erythocyte, stem cells, sperm, E. Coli, yeasts and other cellular microorganisms, etc.) or multicellular tissues (skin, blood vessels, organs, embryos, etc.). The method, vitrification solutions and rehydration solutions described herein minimize toxicity of the vitrification and rehydration solutions and increase intracellular and extracellular vitrification temperatures.

The method includes the step of contacting a specimen or sample with a cryopreservation or vitrification solution. The cryopreservation solution includes a permeating (i.e., low molecular weight) cryoprotectant, a non-permeating (i.e., high molecular weight) cryoprotectant and a non-permeating co-solute that effectively decrease the chemical potential of penetrating cryoprotectants in the vitrification solution. Addition of high molecular weight non-permeating cryoprotectants will increase the vitrification temperature of the cryopreservation solution outside cells. The co-solutes will limit the amount of permeating cryoprotectants that move inside cells and therefore increase the mass/mass ratio of intracellular protein to permeating cryoprotectant in a dehydrated specimen in cryopreservation solution. This will increase the intracellular vitrification temperature for a given osmotic pressure of cryopreservation solution.

The more co-solutes added, the less cryoprotectant penetrates inside the specimen. The more protein/cryoprotectant ratio inside cells, the higher the intracellular vitrification temperature. However, some minimum amount of cryoprotectant is required inside the cells of the specimen in order to protect the cells against dehydration. For this reason, the concentration of the co-solutes that can be added is limited. The maximum concentration of co-solutes that can be added to cryopreservation solution, to limit penetration of cryoprotectant inside cells, depends upon the minimum amount of cryoprotectant required to protect cells against dehydration in cryopreservation solution. The maximum concentration of co-solutes can be found experimentally for every specific type of permeating cryoprotectants, osmotic pressure of cryopreservation solution, type of co-solute and type of specimen.

As noted above, the invention provides a method for shelf preservation of cells and multicellular specimens at refrigeration or higher temperatures. To increase vitrification temperature outside the cells, cryopreservation solution should contain high molecular weight cryoprotectants, such as dextrans, starches, polyethylene glycol, polyvinylpyrrolidone, Ficol, peptides, etc.

Co-solutes that decrease the chemical potential of penetrating cryoprotectants in aqueous solutions include, but are not limited to:
1. Amino acids: glycine, alanine, glutamic acid, proline, valine, hydroxy-1-proline, beta-aminopropionic acid, aminobutyric acid, beta-ainocaproic acid, aminoisobutyric acid, N-methylglycine, norvaline, and others that are soluble in water in concentration >0.1 mol/l, and derivatives of amino acids (sarcosine, iminodiacetic acid, hydroxyethyl glycine, etc.) that are soluble in water in concentration >0.1 mol/l.
2. Betaines: betaine and other betaines that are soluble in water in concentration >0.1 mol/l.
3. Carbohydrates: monosaccharide (aldose and ketoses) glyceraldehyde, lyxose, ribose, xylose, galactose, glucose, hexose, mannose, talose, heptose, dihydroxyacetone, pentulose, hexulose, heptulose, octulose, etc., and their derivatives
a. Amino sugars: D-ribose,3-amino-3-deoxy-, chitosamine, fucosamine, etc.;
b. Alditols and inositols: glycerol, erythritol, arabinitol, ribitol, mannitol, iditol, betitol, inositol, etc.;
c. Aldonic, uronic, and aldaric acids that are soluble in water in concentration >0.1 mol/l.; and
d. disaccharides (sucrose, trehalose, etc.).
4. Sugar alcohols (sorbitol, etc.).

To obtain a high intracellular vitrification temperature, the cells should be substantially dehydrated. The dehydration damages the cells due to large repulsive forces between macromolecules inside cells. A small amount of cryoprotectant should be present inside cells in order to decrease these forces. However, the amount of cryoprotectant inside the cells should be kept as low as possible to decrease the toxic effect of the vitrification solution and to increase the intracellular vitrification temperature. All these requirements can be achieved by using cryopreservation solution that contain mixtures of permeating (i.e., low molecular weight) and non-permeating (i.e., high molecular weight) cryoprotectants along with non-permeating co-solutes (amino acids, betaines, sugars, etc. in concentrations from 0.1-0.6 mol/l) that effectively decrease the chemical potential of penetrating cryoprotectants in cryopreservation solution.

After dehydration in cryopreservation (vitrification) solution, cells can be stored at a temperature that is lower than the vitrification temperatures both inside and outside the cells of the specimen. Prior to dehydration, cells may be loaded in a low concentration (5-40 wt %), non-damaging solution of permeating cryoprotectant to protect cells from damage during dehydration in cryopreservation solution.

After storage, the samples should be rehydrated and returned to normal physiological medium. In other words, intracellular cryoprotectant should be removed from the cells and exchanged for water. It is believed that damage during rehydration, when cells are transferred from cryopreservation (vitrification) solution to a rehydration (washing) solution, occurs because of an increase in cellular volume beyond initial cellular volumes. To avoid this possibility of damage, one has to include in rehydration solutions, co-solutes, as described above, such as: amino acids, betaines, carbohydrates, or other non-permeating co-solutes that effectively decrease the chemical potential of permeating cryoprotectants in aqueous solutions. The co-solutes are used in concentrations from 0.1-0.6 mol/l. Higher co-solute concentrations will more effectively limit the mass of intracellular cryoprotectants, however, when this mass gets very small, the dehydrated cells may be damaged.

The invention allows one to significantly decrease the osmotic pressure of vitrification solution required to obtain a stable vitrification of cells during cooling, to significantly increase extracellular and intracellular vitrification temperatures and the time of cell equilibration (dehydration) in the vitrification solution, without increasing cell damage. This allows one to solve many related problems occurring during equilibration in vitrification solution, storage and rehydration and washing out of intracellular cryoprotectant.

To improve the ability of cells to survive the cryopreservation process described herein, the amounts of permeating cryoprotectant and other components of the cryopreservation solution may be increased in the cryopreservation solution in a stepwise fashion, a linear fashion or according to a desired profile from an initial concentration (.gtoreq.0%) to an optimal final concentration. The cryopreservation solution and the relative amounts of components thereof may be controlled mechanically or manually. Similarly, to optimize the rehydration process, the contents of the rehydration solution and timing of the rehydration process can be similarly controlled. The optimal initial and final concentrations, as well as the optimum method for increasing the relative concentrations of the components of the cryopreservation and rehydration solutions is determined empirically.

By increasing the intracellular and extracellular vitrification temperatures, one will be able to increase storage temperature up to refrigeration or even room temperature and, therefore, develop method of long-term shelf preservation of cells.

By increasing the equilibration time in vitrification solution, osmotic pressure gradients arising during dehydration of multicellular specimens can be decreased. This is a very important matter because if a portion of cells in the sample is less dehydrated than other portions, it may freeze during subsequent cooling and be damaged.

Limiting the amount of cryoprotectant inside cells simplifies the washing out procedure or completely avoids washing of the intracellular cryoprotectant from cells prior to transfusion or transplantation. This is a very important achievement for blood transfusion, transplantation of embryos and artificial insemination services.

The method of the present invention encompasses dehydration of specimens, cooling samples to a storage temperature, warming of the samples to ambient temperature, rehydration and washing out of cryoprotectants in rehydration solution, and returning to normal physiological conditions for various medical procedures (transfusions, transplantation, etc.).

The above invention has been described with reference to the preferred embodiment. Obvious modifications and alterations will occur to others upon reading and understanding the preceding detailed description. It is intended that the invention be construed as including all such modifications and alterations insofar as they come within the scope of the appended claims or the equivalents thereof.

### REFERENCES

Bronshtein, V. L. 1995. A heresy about an organ cryopreservation by vitrification. In: “Cryo'95 program,” Abstract P2-66 of a Paper Presented at the 32nd Annual Meeting of the Society for Cryobiology, Madison, Wis.

Bronshtein, V. L. 1995. Binding, of protectants to the biological macromolecules. In: “Cryo '95 program”, Abstract P2-65 of a Paper Presented at the 32nd Annual Meeting of the Society for Cryobiology, Madison, Wis.

Bronshteyn, V. L. and Steponkus, P. L. 1994. Amino acids and carbohydrates limit permeation of ethylene glycol in Drosophila melanogaster embryos. In: “Abstract of Papers Presented at the 31st Annual Meeting of the Society for Cryobiology,” Abstract 54, Kyoto, Japan.

Bronshteyn, V. L. and Steponkus, P. L. 1993. Differential scanning calorimeter studies of heterogeneous ice nucleation in Drosophila melanogaster embryos. In: “Abstract of Papers Presented at the 30th Annual Meeting of the Society for Cryobiology”, Abstract 22, Atlanta, Ga.

Bronshteyn, V. L. and Steponkus, P. L. 1992. Differential scanning calorimeter studies of ice formation in Drosophila melanogaster embryos. Cryobiology 29:764-765.(Abstract)

Bryant, G. and Wolfe, J. Interfacial forces in cryobiology and anhydrobiology. Cryo-Letters 13, 23-36, 1992.

Crowe, J. H., Carpenter, J. F., Crowe, L. M. and Anchorodoguy, T. J. (1990). Are freezing and dehydration similar stress vectors? A comparison of modes of interaction of stabilizing solutes with biomolecules, Cryobiology 27: 219-231.

Fahy, G. M., Lilley, T. H., Linsdell, H., St. John Douglas M. and Meryman, H. T. 1990. Protectant toxicity and protectant toxicity reduction: In search of molecular mechanisms. Cryobiology 27:247-268.

Fahy, G. M., MacFarlane, D. R., Angell, C. A. and Meryman, H. T. 1984. Vitrification as an approach to cryopreservation. Cryobiology 21:407-426.

Gekko, K. and Timasheff, S. N. 1981. Mechanism of stabilization by glycerol: Preferential hydration in glycerol-water mixtures. Biochemistry 20: 4667-76.

Langis, R. and Steponkus, P. L. 1990. Cryopreservation of rye protoplasts by vitrification. Plant Physiol. 92:666-671.

Lee, J. C. and Timasheff, S. N. (1981) The stabilization of proteins by sucrose. J. Biol. Chem. 256: 7193-7201

Kasai, M., Komi, J. H., Takakamo, A., Tsudera, H., Sakurai, T. and Machida, T. 1990. A simple method for mouse embryo cryopreservation in a low toxicity vitrification solution, without appreciable loss of viability. J. Reprod. Fertil. 89:91-97.

Kedem, O. and Katchalsky, A. (1958) Thermodynamic analysis of the permeability of biological membranes to non-electrolytes. Biochem. Biophys. Acta 27:229-246.

Meryman, H. T. 1967. The relationship between dehydration and freezing injury in the human, erythrocyte. In: Cellular Injury and Resistance in Freezing Organisms. Vol. 11, edited by E. Asahina. pp. 231-244. Institute of Low Temperature Science, Hokkaido University, Sapporo, Japan.

Meryman, H. T. 1970. The exceeding of a minimum tolerable cell volume in hypertonic suspension as a cause of freezing injury. In: The Frozen Cell, edited by G. E. W. Wolstenholme and M. O'Conner. pp. 51-67. J. & A. Churchill, London.

Rall, W. F. and Fahy, G. M. 1985a. Vitrification: A new approach to embryo cryopreservation. Theriogenology 23:220.

Rall, W. F. and Fahy, G. M. 1985b. Ice-free cryopreservation of mouse embryos at −196.degree. C. by vitrification. Nature 313:573-575.

Steponkus, P. L., Bronshteyn, V. L. and Caldwell, Sh. 1994. Cryopreservation of Drosophila melanogaster embryos: Formulation of improved vitrification solutions. In: “Abstract of Papers Presented at the 31st Annual Meeting tcDr of the Society for Cryobiology”, Abstract 51, Kyoto, Japan.

Steponkus, P. L., Langis, R. and Fujikawa, S. 1992. Cryopreservation of plant tissues by vitrification. In: Advances in Low-Temperature Biology, Vol. 1, edited by P. L. Steponkus. pp. 1-61. JAI Press, Ltd., London.

Tachikawa, S., Otoi, T., Kondo, S., Machida, T. and Kasai, M. 1993. Successful vitrification of bovine blastocysts, derived by in vitro maturation and fertilization. Mol. Reprod. Dev. 34:266-271.

Timasheff, S. N. 1993. The control of protein stability and association by weak interaction with water: How do solvents affect these processes? Annu. Rev. Biophys. Biolmol. Strict. 22: 67-97.

Zhu, S. E., Kasai, M., Otoge, H., Sakurai, T. and Machida, T. 1993. Cryopreservation of expanded mouse blastocysts by vitrification in ethylene glycol-based solutions. J. Reprod. Fertil. 98:139-145.

I claim:

1. A method for preserving a cell or tissue specimen by vitrification without ice formation comprising:
(a) loading of a cell or tissue specimen with permeating cryoprotectant by equilibration of the specimen at an ambient temperature in loading solution comprising permeating protectant in concentration 5 to 40% by weight;
(b) dehydrating the loaded specimen in vitrification solution comprising a permeating cryoprotectant in concentration of at least 42% by weight, non-permeating co-solute in concentration of between 0.3-0.7 mol/l, wherein the non-permeating co-solute limits the amount of a permeating cryoprotectant permeating into the specimen by decreasing the chemical potential of the permeating protectant, and a non-permeating high molecular weight cryoprotectant where high molecular weight cryoprotectant serves to increase the glass transition temperature of vitrification solution surrounding the specimen;
(c) cooling the dehydrated specimen from ambient temperature to an appropriate storage temperature below 0° C.;
(d) long-term storing the specimen at the storage temperature for at least thirty days;
(e) warming the specimen from the storage temperature to ambient temperature; and
(f) rehydrating and unloading the dehydrated specimen by contacting said specimen with a washing solution comprising a non-permeating co-solute, wherein said non-permeating co-solute decreases the chemical potential of the permeating cryoprotectant.

2. The method of claim 1, wherein the permeating cryoprotectant is selected from the group consisting of dimethylsulfoxide, ethylene glycol, propylene glycol, and glycerol.

3. The method of claim 1, wherein the non-permeating high molecular weight cryoprotectant is selected from the group consisting of dextrans, starches, polyethylene glycol, polyvinyl pyrrolidone, Ficoll and peptides.

4. The method of claim 1, wherein the non-permeating co-solute is selected from the group comprising amino acids, betaine, carbohydrates, and sugar alcohols.

5. The method of claim 4, wherein the carbohydrate is selected from the group consisting of a disaccharide, an aldose monosaccharide, a ketose monosaccharide, an aminosugar, an alditol, an inositol, an aidonic acid, a uronic acid, and an aldaric acid.

6. The method of claim 1, wherein the step of dehydrating the specimen is performed by contacting the specimen with increasingly higher concentrations of the permeating cryoprotectant and the co-solute.

7. The method of claim 1, wherein the concentration of non-permeating co-solute in the vitrification solution is between 0.3 and 0.7 mol/l.

8. The method of claim 4, wherein the non-permeating co-solute is an amino acid.

9. The method of claim 6, wherein concentrations of the permeating cryoprotectant and the co-solute are simultaneously increased from an initial concentration to a final concentration according to a desired profile.

10. The method of claim 1, wherein the step of rehydrating and unloading the specimen is performed by contacting the specimen with a washing solution comprising a non-permeating co-solute, where said non-permeating co-solute decreases the chemical potential of a permeating rehydration cryoprotectant.

11. The method of claim 10, wherein the non-permeating co-solute is selected from the group comprising amino acids and their derivatives, betaine, carbohydrates, and sugar alcohols.

12. The method of claim 11, wherein the carbohydrate is selected from the group consisting of a disaccharide, an aldose monosaccharide, a ketose monosaccharide, an aminosugar, an alditol, an inositol, an aidonic acid, a uronic acid, and an aldaric acid.

13. The method of claim 1, wherein ambient temperature is room temperature.

14. A dehydrating and loading solution for preserving a cell or tissue specimen by vitrification without ice formation comprising a permeating cryoprotectant, a non-permeating high molecular weight cryoprotectant, and a non-permeating co-solute.

15. The solution of claim 14, wherein the permeating cryoprotectant is selected from the group consisting of dimethylsulfoxide, ethylene glycol, propylene glycol and glycerol.

16. The solution of claim 14, wherein the non-permeating high molecular weight cryoprotectant is selected from the groups consisting of dextrans, starches, polyethylene glycol, polyvinylpyrrolidone, Ficoll and peptides.

17. The solution of claim 14, wherein the non-permeating co-solute is selected from a group comprising amino acids, betaine, carbohydrates, and sugar alcohols.

18. The solution of claim 17, wherein the carbohydrate is selected from a group consisting of a disaccharide, an aldose monosaccharide, a ketose monosaccharide, an aminosugar, an alditol, an inositol, an aidonic acid, a uronic acid, and an aldaric acid.

19. A rehydrating and unloading solution for preserving a cell or tissue specimen by vitrification without ice formation comprising a non-permeating co-solute, wherein said non-permeating co-solute decreases the chemical potential of the permeating cryoprotectant.

20. The solution of claim 19, wherein the non-permeating co-solute is selected from the group comprising amino acids, betaine, carbohydrates, and sugar alcohols.

21. The solution of claim 20, wherein the carbohydrate is selected from a group consisting of a disaccharide, an aldose monosaccharide, a ketose monosaccharide, an aminosugar, an alditol, an inositol, an aidonic acid, a uronic acid, and an aldaric acid.
